(19) United States
(12) Patent Application Publication
(10) Pub. No.: US 2024/0211370 A1
(43) Pub. Date: Jun. 27, 2024

(54) NATURAL LANGUAGE BASED MACHINE LEARNING MODEL DEVELOPMENT, REFINEMENT, AND CONVERSION

(71) Applicant: Optum Services (Ireland) Limited, Dublin (IE)

(72) Inventor: Riccardo MATTIVI, Dublin (IE)

(21) Appl. No.: 18/145,576

(22) Filed: Dec. 22, 2022

(51) Int. Cl. G06F 11/34; G06N 20/00

(52) U.S. Cl. CPC G06F 11/3428; G06N 20/00

(57) ABSTRACT

Various embodiments of the present disclosure disclose model training processes facilitated by specialized interactive user interfaces. A user interface may provide a natural language rule described by natural language text to a user for review. The user may verify or modify the natural language rule to establish a performance condition for a machine learning model. The natural language rule may be converted to a computer interpretable rule that may be used as a labeling function for the performance condition. Using weak supervision techniques, the labeling function may be applied to a training dataset to generate a labeled training dataset. A machine learning model may be trained using the labeled training dataset. Once trained, the model may be evaluated and evaluation data may be provided to the user. The user may perform multiple iterations of the training process to refine, add, or delete natural language rules for training the model.

### BACKGROUND

Various embodiments of the present disclosure address technical challenges related to the development, refinement, and conversion of machine learning models given limitations of existing machine learning development techniques. Existing processes for developing machine learning models, for example, may be complex, rely on legacy technology, and/or require domain knowledge/experience to be shared across and interpreted by a number of different specialized entities. These drawbacks make the creation and/or the refinement of new machine learning models tedious, expensive, and prone to performance losses, and the conversion of legacy rules-based models to modern machine learning models prohibitively expensive. Various embodiments of the present disclosure make important contributions to various existing machine learning model development techniques by addressing each of these technical challenges.

### BRIEF SUMMARY

Various embodiments of the present disclosure disclose end-to-end model training processes facilitated by specialized interactive user interfaces. Conventional model development techniques are disjointed and rely on the disparate subject matter expertise of multiple different parties. An end-to-end model training process of the present disclosure enables one user to develop, refine, and/or convert a machine learning model through an iterative process based on user interpretable natural language rules and feedback comparing the natural language rules to the performance of the machine learning model. An interactive user interface of the present disclosure provides specialized user interfaces and artificial intelligent tools specifically tailored to each step of the end-to-end model training process. Using the techniques of the present disclosure, machine learning models may be efficiently developed and continuously refined, as performance conditions change, in a time efficient manner without sacrificing the reliability and accuracy of the resulting machine learning models.

In some embodiments, a computer-implemented method comprises providing for display, by one or more processors and via an interactive user interface, a natural language rule comprising natural language text indicative of a performance condition for a machine learning model; generating, by the one or more processors and using a natural language model, a computer interpretable rule corresponding to the natural language rule based at least in part on the natural language text, wherein the computer interpretable rule comprises a labeling function that corresponds to the performance condition; generating, by the one or more processors and using a weak supervision model, a labeled training dataset based at least in part on the computer interpretable rule; generating, by the one or more processors, the machine learning model based at least in part on the labeled training dataset; and providing for display, by the one or more processors and via the interactive user interface, evaluation data for the machine learning model.

In some embodiments, a computing apparatus comprising at least one processor and at least one memory including program code is provided. The at least one memory and the program code are configured to, upon execution by the at least one processor, cause the computing apparatus to: provide for display, via an interactive user interface, a natural language rule comprising natural language text indicative of a performance condition for a machine learning model; generate, using a natural language model, a computer interpretable rule corresponding to the natural language rule based at least in part on the natural language text, wherein the computer interpretable rule comprises a labeling function that corresponds to the performance condition; generate, using a weak supervision model, a labeled training dataset based at least in part on the computer interpretable rule; generate the machine learning model based at least in part on the labeled training dataset; and provide for display, via the interactive user interface, evaluation data for the machine learning model.

In some embodiments, a non-transitory computer storage medium includes instructions that, when executed by one or more processors, cause the one or more processors to: provide for display, via an interactive user interface, a natural language rule comprising natural language text indicative of a performance condition for a machine learning model; generate, using a natural language model, a computer interpretable rule corresponding to the natural language rule based at least in part on the natural language text, wherein the computer interpretable rule comprises a labeling function that corresponds to the performance condition; generate, using a weak supervision model, a labeled training dataset based at least in part on the computer interpretable rule; generate the machine learning model based at least in part on the labeled training dataset; and provide for display, via the interactive user interface, evaluation data for the machine learning model.

### BRIEF DESCRIPTION OF THE DRAWINGS

FIG. 1 illustrates an example computing system in accordance with some embodiments of the present disclosure.

FIG. 2 is a schematic diagram showing a system computing architecture in accordance with some embodiments discussed herein.

FIG. 3 is a flowchart showing an example of a process for generating a machine learning model based on natural language text in accordance with some embodiments discussed herein.

FIG. 4 depicts an operational example of an interactive user interface in accordance with some embodiments discussed herein.

FIG. 5 depicts another operational example of the interactive user interface in accordance with some embodiments discussed herein.

FIG. 6 depicts operational examples of natural language rules and computer interpretable rules in accordance with some embodiments discussed herein.

FIG. 7 depicts an operational example for generating a machine learning model using weak supervision techniques in accordance with some embodiments discussed herein.

FIG. 8 depicts an operational example of an iterative model training process in accordance with some embodiments discussed herein.

FIG. 9 depicts an operational example of an iterative model training process in accordance with some embodiments discussed herein.

FIG. 10 depicts an operational example of a rule modification to a natural language rule via an interactive user interface in accordance with some embodiments discussed herein.

FIG. 11 depicts an operational example of an iterative model training process in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on, or based solely on, the referenced element or elements unless so indicated. Like numbers refer to like elements throughout. Moreover, while certain embodiments of the present disclosure are described with reference to predictive data analysis, one of ordinary skill in the art will recognize that the disclosed concepts may be used to perform other types of data analysis.

### I. OVERVIEW, TECHNICAL IMPROVEMENTS, AND TECHNICAL ADVANTAGES

Embodiments of the present disclosure present new model development techniques that improve machine learning model development, refinement, and conversion from other legacy systems. The present disclosure provides an end-to-end model training process facilitated by an interactive user interface. Conventional model development techniques are disjointed and rely on the disparate subject matter expertise of multiple different parties. The end-to-end model training process of the present disclosure enables one user to develop, refine, and/or convert a machine learning model through an iterative process based on user interpretable natural language rules and feedback comparing the natural language rules to the performance of the machine learning model. In some embodiments, the interactive user interface provides specialized user interfaces and artificial intelligent tools specifically tailored to each step of the end-to-end model training process. As described herein, the interfaces and tools of the interactive user interface streamline the development, refinement, and conversion of machine learning models such that the entire end-to-end process may be performed by a single user. In this way, the present disclosure provides improved machine learning development techniques that utilize specialized user interfaces and machine learning techniques to facilitate the development, refinement, and conversion of machine learning models. Using the techniques of the present disclosure, machine learning models may be efficiently developed and continuously refined, as performance conditions change, in a time efficient manner without sacrificing the reliability and accuracy of the resulting machine learning models.

In some embodiments, the end-to-end model training process includes receiving natural language text input for defining one or more natural language rules for a machine learning model. In some embodiments, each natural language rule corresponds to a desired performance condition for the machine learning model. The end-to-end model training process includes converting the natural language rules to corresponding computer interpretable rules and leveraging weakly supervised machine learning approaches to use the computer interpretable rules to label a training dataset. In some embodiments, the labeled training dataset is used to train a machine learning model. The end-to-end model training process includes evaluating and providing feedback on the performance of the machine learning model. In this way, weakly supervised machine learning approaches are utilized to receive timely feedback on how the machine learning model performs compared to how it is desired to perform. This feedback is then be used to refine the model through subsequent iterations of the end-to-end model training process in which new and/or modified natural language rules are provided. In this manner, the end-to-end model training process provides an approach to machine learning development, refinement, and/or conversion that is effortless and allows for faster, easier, and more accurate outcomes.

In some embodiments, the interactive user interface empowers a user to perform one or more steps of the end-to-end training process by providing specialized interfaces and artificial intelligence tools for inputting and/or refining natural language rules that ultimately govern the performance of the machine learning model. In some embodiments, the interactive user interface provides real time labels as a user provides and/or refines a natural language rule that intelligently identifies portions of the rule and explains the potential impact of each portion on the performance of a machine learning model. Moreover, the interactive user interface provides continuous feedback on the performance of a machine learning model to enable a user to refine, add, and/or remove natural language rules through iterations of the machine learning model development, refinement, and/or conversion process.

Example inventive and technologically advantageous embodiments of the present disclosure include: (i) an end-to-end model training process designed to facilitate the creation of machine learning models based on user interpretable natural language rules, (ii) iterative techniques for iteratively providing evaluation data for a machine learning model to facilitate the refinement of natural language rules governing the performance of the machine learning model, (iii) the use of weakly supervised machine learning approaches for training a machine learning model using natural language based labeling rules, and (iv) a specialized user interface for intelligently creating natural language rules and providing evaluation data for the natural language rules to allow for the informed development and refinement of a machine learning model.

Various embodiments of the disclosure are described herein using several different example terms.

In some embodiments, the term “interactive user interface” refers to an interface configured to display user interpretable information to a user of the interface and/or receive user input from the user. The user interpretable information may be associated with one or more rules, performance conditions, functions, evaluations, and/or any other information related to a machine learning model. As one example, the user interpretable information may include one or more natural language rules that describe performance conditions for a machine learning model. As another example, the user interpretable information may include evaluation data that describes one or more outputs and/or performance metrics for the machine learning model. By presenting such data to a user, the interactive user interface may facilitate the intelligent design and generation of a machine learning model using natural language.

The interactive user interface may include artificial intelligence mechanisms for assisting a user in the development of a machine learning model by enabling the creation of new natural language rules and/or modifications to existing natural language rules. For instance, the interactive user interface may be configured to receive (e.g., through one or more input devices such keyboards, microphones, and/or the like) user input from a user that describes one or more performance conditions for a machine learning model. As one example, the user input may include natural language text input from the user that describes the performance condition in natural language (e.g., plain English, and/or the like). As another example, the natural language text input may describe a rule modification to an existing natural language rule intended to cover the performance condition.

The artificial intelligence mechanisms of the interactive user interface may be configured to analyze natural language text input by the user to provide one or more insights for assisting the generation/modification of a natural language rule to cover a performance condition. For instance, the interactive user interface may leverage natural language interpretation functionalities (e.g., natural language models, and/or the like) to identify and, in some embodiments, emphasize rule attributes represented by the natural language text of a natural language rule that may be instructive for training a machine learning model. For instance, the interactive user interface may assign a real time label to an identified rule attribute of a natural language rule and provide a visual representation of the real time label to the user. By doing so, the interactive user interface may facilitate an understanding of a natural language text's potential impact to a machine learning model in real time as the text is provided by the user. The interactive user interface may receive labeling input for the real time label to confirm and/or modify the real time label. For instance, in the event that a user disagrees with a real time label, the labeling input may include a label modification to improve the interactive user interface's interpretation of the natural language text. In some embodiments, such modifications may be used to improve the natural language interpretation functionalities (e.g., machine learning natural language models, and/or the like) leveraged by the interactive user interface.

The interactive user interface may further provide evaluation data for a machine learning model that is trained, using the techniques described herein, based on natural language rules provided by a user. The evaluation data may illustrate the relative performance of the machine learning model as natural language rules are provided to the interactive user interface. This may allow the user to track the progress of the machine learning model as new performance conditions are introduced through natural language text over a number of training iterations.

In this way, the interactive user interface may enable a user to efficiently and effectively convert a concept with one or more conceptual performance conditions into a machine learning model using natural language text. In addition, the interactive user interface may be utilized to easily and accurately improve and/or update existing machine learning models in the event performance conditions change. Moreover, the interactive user interface may seamlessly automate the transition from legacy rule-based approaches to machine learning models.

In some embodiments, the term “predictive machine learning model” refers to a data entity that describes parameters, hyper-parameters, and/or defined operations of a machine learning model (e.g., model including at least one of one or more rule-based layers, one or more layers that depend on trained parameters, coefficients, and/or the like). The predictive machine learning model may be trained to perform a classification, prediction, and/or any other computing task. The predictive machine learning model may include one or more of any type of machine learning model including one or more supervised, unsupervised, semi-supervised, and/or reinforcement learning models. In some embodiments, the predictive machine learning model may include multiple models configured to perform one or more different stages of a classification, prediction, and/or the like computing task.

As one example, a predictive machine learning model may include a classification model trained, using one or more semi-supervised and/or supervisory training techniques, to output a classification output predicted to correspond to an input data object. The classification output, for example, may include a discrete value output for a particular input data object. In some embodiments, the predictive machine learning model may be trained using a labeled training dataset that includes a plurality of synthetic and/or historical input data objects with a plurality of labels identifying ground truth classifications respectively corresponding to the plurality of synthetic and/or historical input data objects.

The predictive machine learning model, the classification output, and/or the input data object may each depend on the use case. As one example use case provided for illustration purposes only, the techniques of the present disclosure may be applied to a medical claim verification process in which a medical claim may be approved or denied based on a plurality of constantly changing business, policy, and/or contractual conditions. In such a case, the predictive machine learning model may include a fraud waste abuse and error (FWAE) model, the input data object may include a medical claim, and the classification output may include a predictive classification indicative of whether the claim should be denied or approved. The machine learning FWAE model may be trained using a labeled training dataset with a plurality of claims that are labeled according to performance conditions for a specific business entity.

In some embodiments, the term “performance condition” refers to a data entity that describes a desired condition for the predictive machine learning model. A performance condition may be based on criteria for evaluating an input to the predictive machine learning model such that the type, number, and/or substance of performance conditions for the predictive machine learning model may depend on the use case for the machine learning model. As one example use case, the predictive machine learning model may include an FWAE model utilized to verify medical claims. In such a case, a performance condition may be based on criteria for evaluating a medical claim such as business policies and/or contracts, medical trends, treatment efficacy research, industry standards, and/or the like. The criteria for evaluating a medical claim may be complex, complicated, and may dynamically change based on an entity's business relationships and/or ongoing research/best practices. Typically, performance conditions based on such criteria may rely on domain knowledge shared among Subject Matter Experts (SMEs) in the field. As businesses transform, the performance conditions may be adapted to accommodate for changing criteria.

In some embodiments, the term “natural language rule” refers to a data entity that describes a user interpretable rule corresponding to a performance condition for a machine learning model. The natural language rule may include natural language text. For example, the natural language text may include a sequence of natural language words, phrases, and/or the like. The natural language text, for example, may include a series of sentences describing one or more performance conditions for a machine learning model. In some embodiments, a natural language rule may include a sentence that describes a performance condition for a machine learning model. The natural language text may include plain language (e.g., plain English, and/or the like) written, typed, and/or provided according to a linguistic structure governing the plain language. The plain language may include any language interpretable by a human such as natural English language.

In some embodiments, the term “rule database” refers to a data entity that describes a plurality of rules for one or more predictive models. The rule database may include any type of data structure including, as examples, one or more relational databases, knowledge graphs, hierarchical databases, network databases, object-oriented databases, NoSQL databases, and/or the like. The rules may include a plurality of natural language rules, a plurality of computer interpretable rules, a plurality of structured language rules, and/or the like. The rule database may include one or more rule associations that may identify one or more correlations between the rules. By way of example, each rule association may respectively describe an associated set of rules. A rule association, for example, may identify at least a computer interpretable rule corresponding to a respective natural language rule. A computer interpretable rule, for example, may be stored in the rule database in association with a corresponding natural language rule.

In some embodiments, the rule database may include contextual data for at least one rule (e.g., natural language rule, computer interpretable rule, structured language rule, and/or the like). The contextual data may identify one or more contextual attributes for the rule such as a number and/or model characteristics of one or more predictive models that are associated (e.g., defined by, trained using, and/or the like) with the rule, a performance condition corresponding to the rule, an age and/or developer of the rule, and/or the like.

In some embodiments, the term “computer interpretable rule” refers to a data entity that describes a computer interpretable constraint corresponding to a performance condition. In some embodiments, the computer interpretable rule may include a labeling function generated for a performance condition. Using some of the techniques described herein, the computer interpretable rule may be generated based on a natural language rule and/or a structured language rule. In some embodiments, the computer interpretable rule may include a segment of program code that is executable to perform a labeling function for a training dataset. The computer interpretable rule may be generated based on a computer-interpretable template and/or one or more rule attributes.

In some embodiments, the term “computer interpretable template” refers to a data entity that describes a predefined template for generating a computer interpretable rule based on one or more rule attributes. The computer interpretable template may include a segment of program code that is modifiable to account for the rule attributes. By way of example, the segment of program code may include an executable if-then statement. The segment of program code may be implemented in assembly languages, programming languages, such as Python, Java, C, and/or the like. In some embodiments, a computer interpretable template may be selected from a plurality of computer interpretable templates based on one or more rule attributes. By way of example, the computer interpretable templates may include a respective computer interpretable template for each of a plurality of different types and/or combinations of rule attributes. In addition, or alternatively, in some embodiments, the computer interpretable template may be based on a domain. For example, a respective computer interpretable template may be selected based on a domain associated with the predictive machine learning model.

In some embodiments, the term “rule attribute” refers to a data entity that describes a portion of information that may be relevant for a constraint corresponding to a performance condition. In some embodiments, a rule attribute may be extracted from a natural language rule and/or a structured language rule. A rule attribute, for example, may correspond to a portion of text from a natural language rule and/or a portion of code from a structured language rule. In some embodiments, the extracted rule attributes may be leveraged to augment a corresponding computer interpretable template to generate a computer interpretable rule.

The rule attributes may depend on the use case. In one example use case, the predictive machine learning model may include an FWAE model utilized to verify medical claims. In such a case, the rule attributes may include portions of information that may be relevant for enforcing a performance condition for verifying medical claims. Such attributes may include, as examples, current procedural terminology (CPT) codes, code modifiers, target diagnoses, and/or the like.

In some embodiments, the term “real time label” refers to a data entity that describes a characteristic of a rule attribute. A real time label, for example, may identify a type of rule attribute and/or one or more other insights into how the rule attribute may be used to generate a computer interpretable rule. By way of example, a computer interpretable template may include a plurality of modifiable locations in which certain types of rule attributes may be placed. A real time label may identify where a rule attribute may be placed within a computer interpretable template. As one example, a computer interpretable template may include a first modifiable location designated for rule attributes of a first type (e.g., CPT codes in an FWAE use case), a second modifiable location designated for rule attributes of a second type (e.g., modifier codes in an FWAE use case), and/or a third modifiable location designated for rule attributes of a third type (e.g., target diagnoses in an FWAE use case).

In some embodiments, a real time label may include a sensory indicator (e.g., visual, auditory, and/or the like). By way of example, a real time label may include one or more visual identifiers. A real time label, for example, may correspond to a portion of natural language text and/or structured language text that corresponds to a respective rule attribute. A visual identifier may include a modification to the text color, font, background color, and/or the like associated with the portion of natural language text and/or structured language text. In some embodiments, a portion of natural language text and/or structured language text may be modified to include the visual identifier (e.g., by changing a text color, font, background color, and/or the like).

In some embodiments, the term “natural language model” refers to a data entity that describes parameters, hyper-parameters, and/or defined operations of a rule-based and/or machine learning model (e.g., model including at least one of one or more rule-based layers, one or more layers that depend on trained parameters, coefficients, and/or the like). The natural language model may include one or more of any type of rule-based and/or machine learning model including one or more supervised, unsupervised, semi-supervised, and/or reinforcement learning models. In some embodiments, a natural language model may include multiple models configured to perform one or more different stages of a natural language processing task.

As one example, a machine learning natural language model may include a natural language processor trained to identify rule attributes from natural language text forming one or more natural language rules. The machine learning natural language model may include any type of natural language processor including, as examples, support vector machines, Bayesian networks, maximum entropies, conditional random fields, neural networks, transformers, and/or the like. In some embodiments, the machine learning natural language model may include a name entity recognition model.

In some embodiments, the term “weak supervision model” refers to a data entity that describes parameters, hyper-parameters, and/or defined operations of a rules-based model and/or a machine learning model (e.g., model including at least one of one or more rule-based layers, one or more layers that depend on trained parameters, coefficients, and/or the like). The weak supervision model may include a weakly supervised machine learning model configured to label an unlabeled training dataset using one or more labeling functions and/or the like. The machine learning weak supervision model may include one or more classical and/or deep learning based techniques.

In some embodiments, the term “unlabeled training dataset” refers to a data entity that describes a plurality of at least partially unlabeled input data objects for one or more predictive models. An unlabeled training dataset may include and/or be stored in any type of data structure including, as examples, one or more relational databases, knowledge graphs, hierarchical databases, network databases, object-oriented databases, NoSQL databases, and/or the like. An unlabeled training dataset may describe a plurality of unlabeled synthetic and/or historical input data objects for one or more predictive models. The unlabeled input data objects may be based on the use case. In one example, for an FWAE use case, the unlabeled input data objects may include unprocessed medical claims without an indication of whether the medical claim is approved (e.g., is normal) or denied (e.g., is associated with an overpayment).

In some embodiments, the term “labeled training dataset” refers to a data entity that describes a plurality of labeled input data objects for one or more predictive models. A labeled training dataset may include and/or be stored in any type of data structure including, as examples, one or more relational databases, knowledge graphs, hierarchical databases, network databases, object-oriented databases, NoSQL databases, and/or the like. A labeled training dataset may describe a plurality of labeled synthetic and/or historical input data objects for one or more predictive models. The labeled input data objects may be based on the use case. In one example, for an FWAE use case, the labeled input data objects may include processed medical claims with a label identifying whether the medical claim is approved, denied, and/or any other information/classification. In addition, or alternatively, the labeled input data object may include regression-based labels that include a percentage, ratio, and/or a range of numbers.

In some embodiments, the term “evaluation data” refers to a data entity that describes a performance of the predictive machine learning model. The performance of the predictive machine learning model may be based on outputs of the model and/or performance metrics for the model. The evaluation data, for example, may include a plurality of training outputs for the predictive machine learning model, one or more performance metrics for the predictive machine learning model, and/or any other information representative of the performance of the predictive machine learning model. In some embodiments, the computing system 100 may generate the evaluation data for the machine learning model based on the training outputs, the performance metrics, and/or the like.

In some embodiments, the term “training output” refers to a component of the evaluation data. The training outputs for a predictive machine learning model may include a plurality of outputs generated by the predictive machine learning model based on a training dataset. The training outputs may be generated during an iteration of an iterative model training process in which one or more rules are modified and/or added for consideration of the machine learning model during each iteration. The training output may be analyzed individually and/or in one or more combinations to assess an impact of one or more modified and/or added rules on the outputs of the predictive machine learning model. In this way, the training outputs may help a user verify an efficacy of a natural language rule and/or converge to a final concept defined by a plurality of natural language rules.

In some embodiments, the term “performance metric” refers to another component of the evaluation data. The performance metrics for a predictive machine learning model may include one or more metrics (e.g., false positive rate, false negative rate, L2 scores, precision, recall, AUC, etc.) for the predictive machine learning model based on the training outputs. The performance metrics may be analyzed individually and/or in one or more combinations to assess an impact of one or more modified and/or added rules on the performance of the predictive machine learning model. In this way, the performance metrics may allow a user to track a progress of the predictive machine learning model as rules are added/modified/converted at each iteration of an iterative model training process. In some embodiments, a performance metric may represent a performance of the predictive machine learning model with respect to a previous model.

In some embodiments, the term “previous model” refers to a data entity that describes parameters, hyper-parameters, and/or defined operations of a machine learning model (e.g., model including at least one of one or more rule-based layers, one or more layers that depend on trained parameters, coefficients, and/or the like) and/or any other algorithm. As used herein, the previous model may include a previous version of a predictive machine learning model generated in a previous iteration of the iterative model training process. In addition, or alternatively, the previous model may include a previously deployed machine learning model that is being modified through the iterative model training process to account for one or more performance condition changes. As another example, the previous model may include a rules-based model previously configured to output similar outputs of the predictive machine learning model.

In some embodiments, the term “rules-based model” refers to a data entity that describes parameters, hyper-parameters, and/or defined operations of a rules-based algorithm. A rules-based model may be defined by one or more structured languages. In some embodiments, the rules-based model may be defined by one or more hard coded programming scripts, segments of legacy programming languages, SQL procedures/scripts, and/or the like.

### II. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related, may be stored together such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a non-transitory computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a non-transitory computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### III. EXAMPLE SYSTEM FRAMEWORK

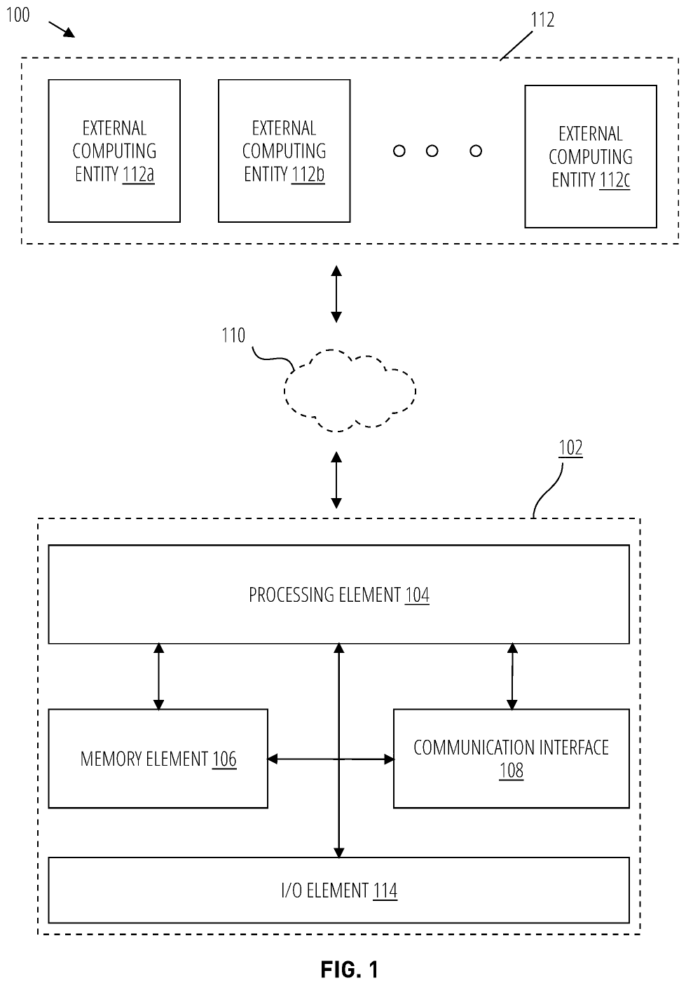

FIG. 1 illustrates an example computing system 100 in accordance with one or more embodiments of the present disclosure. The computing system 100 may include a predictive computing entity 102 and/or one or more external computing entities 112a-c communicatively coupled to the predictive computing entity 102 using one or more wired and/or wireless communication techniques. The predictive computing entity 102 may be specially configured to perform one or more steps/operations of one or more techniques described herein. In some embodiments, the predictive computing entity 102 includes and/or be in association with one or more mobile device(s), desktop computer(s), laptop(s), server(s), cloud computing platform(s), and/or the like. In some example embodiments, the predictive computing entity 102 may be configured to receive and/or transmit one or more datasets, objects, and/or the like from and/or to the external computing entities 112a-c to perform one or more steps/operations of one or more prediction techniques described herein.

The external computing entities 112a-c, for example, may include and/or be associated with one or more data centers, external entities, and/or legacy systems. The data centers, for example, may be associated with one or more data repositories (e.g., rule databases, and/or the like) storing data that can, in some circumstances, be processed by the predictive computing entity 102. By way of example, a data repository may store data related to one or more predictive models. The repository, for example, may include parameters, rules (e.g., natural language rules, computer interpretable rules, structured language rules, and/or the like), performance conditions, and/or evaluation data for the predictive models. In some embodiments, one or more of the external computing entities 112a-c include one or more data processing entities that may receive, store, and/or have access to one or more training datasets for predictive machine learning models. The data processing entities, for example, may maintain training datastore with one or more sets of synthetic and/or historical unlabeled and/or labeled training data. The training data may be based on the prediction domain of a predictive machine learning model.

The predictive computing entity 102 may include, or be in communication with, one or more processing elements 104 (also referred to as processors, processing circuitry, digital circuitry, and/or similar terms used herein interchangeably) that communicate with other elements within the predictive computing entity 102 via a bus, for example. As will be understood, the predictive computing entity 102 may be embodied in a number of different ways. The predictive computing entity 102 may be configured for a particular use or configured to execute instructions stored in volatile or non-volatile media or otherwise accessible to the processing element 104. As such, whether configured by hardware or computer program products, or by a combination thereof, the processing element 104 may be capable of performing steps or operations according to embodiments of the present disclosure when configured accordingly.

In one embodiment, the predictive computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, applications, programs, program modules, scripts, source code, object code, byte code, compiled code, interpreted code, machine code, executable instructions, and/or the like may be used to control certain aspects of the operation of the predictive computing entity 102 with the assistance of the processing element 104.

As indicated, in one embodiment, the predictive computing entity 102 may also include one or more communication interfaces 108 for communicating with various computing entities such as the external computing entities 112a-c, such as by communicating data, content, information, and/or similar terms used herein interchangeably that may be transmitted, received, operated on, processed, displayed, stored, and/or the like.

The computing system 100 may include one or more input/output (I/O) element(s) 114 for communicating with one or more users. An I/O element 114, for example, may include one or more user interfaces for providing and/or receiving information from one or more users of the computing system 100. The I/O element 114 may include one or more tactile interfaces (e.g., keypads, touch screens, etc.), one or more audio interfaces (e.g., microphones, speakers, etc.), visual interfaces (e.g., display devices, etc.), and/or the like. The I/O element 114 may be configured to receive user input through one or more of the user interfaces from a user of the computing system 100 and provide data to a user through the user interfaces.

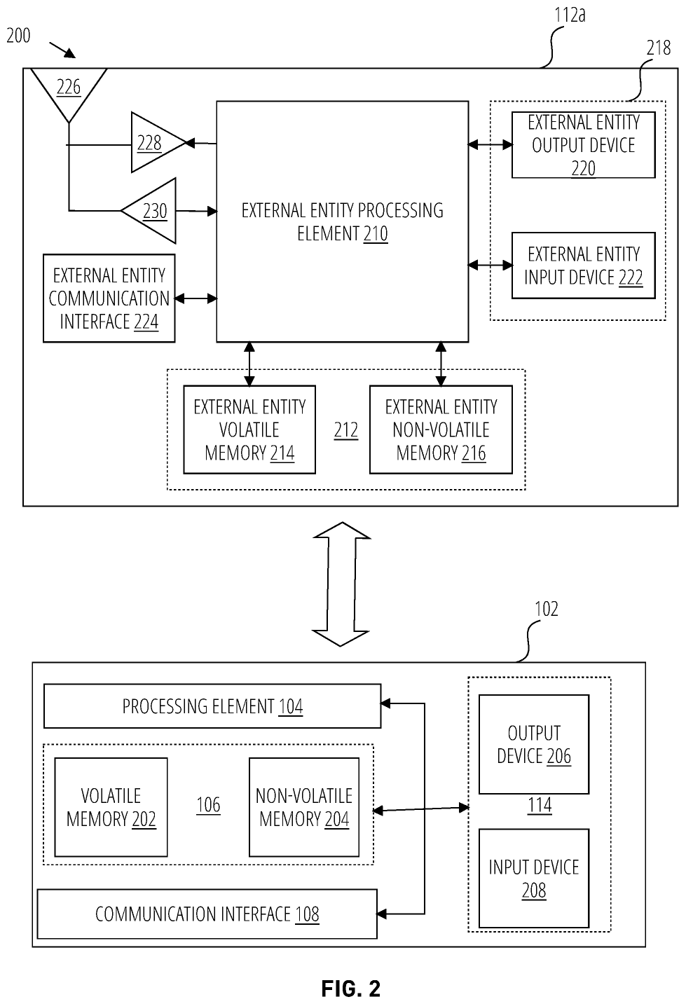

FIG. 2 is a schematic diagram showing a system computing architecture 200 in accordance with some embodiments discussed herein. In some embodiments, the system computing architecture 200 includes the predictive computing entity 102 and/or the external computing entity 112a of the computing system 100. The predictive computing entity 102 and/or the external computing entity 112a may include a computing apparatus, a computing device, and/or any form of computing entity configured to execute instructions stored on a computer-readable storage medium to perform certain steps or operations.

The predictive computing entity 102 may include a processing element 104, a memory element 106, a communication interface 108, and/or one or more I/O elements 114 that communicate within the predictive computing entity 102 via internal communication circuitry such as a communication bus, and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

The memory element 106 may include non-volatile memory 204 (also referred to as non-volatile storage, memory, memory storage, memory circuitry and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the predictive computing entity 102 to perform one or more step/operations described herein.

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as in a particular directory, folder, or library. Software components may be static (e.g., pre-established or fixed) or dynamic (e.g., created or modified at the time of execution).

The predictive computing entity 102 may be embodied by a computer program product include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The predictive computing entity 102 may include one or more I/O elements 114. The I/O elements 114 may include one or more output devices 206 and/or one or more input devices 208 for providing and/or receiving information with a user, respectively. The output devices 206 may include one or more sensory output devices such as one or more tactile output devices (e.g., vibration devices such as direct current motors, and/or the like), one or more visual output devices (e.g., liquid crystal displays, and/or the like), one or more audio output devices (e.g., speakers, and/or the like), and/or the like. The input devices 208 may include one or more sensory input devices such as one or more tactile input devices (e.g., touch sensitive displays, push buttons, and/or the like), one or more audio input devices (e.g., microphones, and/or the like), and/or the like.

In addition, or alternatively, the predictive computing entity 102 may communicate, via a communication interface 108, with one or more external computing entities such as the external computing entity 112a. The communication interface 108 may be compatible with one or more wired and/or wireless communication protocols.

For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the predictive computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The external computing entity 112a may include an external entity processing element 210, an external entity memory element 212, an external entity communication interface 214, and/or one or more external entity I/O elements 218 that communicate within the external computing entity 112a via internal communication circuitry such as a communication bus, and/or the like.

The external entity processing element 210 may include one or more processing devices, processors, and/or any other device, circuitry, and/or the like described with reference to the processing element 104. The external entity memory element 212 may include one or more memory devices, media, and/or the like described with reference to the memory element 106. The external entity memory element 212, for example, may include at least one external entity volatile memory 214 and/or external entity non-volatile memory 216. The external entity communication interface 214 may include one or more wired and/or wireless communication interfaces as described with reference to communication interface 108.

In some embodiments, the external entity communication interface 214 is supported by one or more radio circuitry. For instance, the external computing entity 112a may include an antenna 226, a transmitter 228 (e.g., radio), and/or a receiver 230 (e.g., radio).

Signals provided to and received from the transmitter 228 and the receiver 230, correspondingly, may include signaling information/data in accordance with air interface standards of applicable wireless systems. In this regard, the external computing entity 112a may be capable of operating with one or more air interface standards, communication protocols, modulation types, and access types. More particularly, the external computing entity 112a may operate in accordance with any of a number of wireless communication standards and protocols, such as those described above with regard to the predictive computing entity 102.

Via these communication standards and protocols, the external computing entity 112a may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112a may also download changes, add-ons, and updates, for instance, to its firmware, software (e.g., including executable instructions, applications, program modules), operating system, and/or the like.

According to one embodiment, the external computing entity 112a may include location determining embodiments, devices, modules, functionalities, and/or the like. For example, the external computing entity 112a may include outdoor positioning embodiments, such as a location module adapted to acquire, for example, latitude, longitude, altitude, geocode, course, direction, heading, speed, universal time (UTC), date, and/or various other information/data. In one embodiment, the location module may acquire data such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 112a in connection with a variety of other systems, including cellular towers, Wi-Fi access points, and/or the like. Similarly, the external computing entity 112a may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something to within inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O element 218 includes a user interface (e.g., a display, speaker, and/or the like) and/or a user input interface (e.g., keypad, touch screen, microphone, and/or the like) that may be coupled to the external entity processing element 210.

For example, the user interface may be a user application, browser, and/or similar words used herein interchangeably executing on and/or accessible via the external computing entity 112a to interact with and/or cause the display, announcement, and/or the like of information/data to a user. The user input interface may include any of a number of input devices or interfaces allowing the external computing entity 112a to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112a and may include a full set of alphabetic keys or set of keys that may be activated to provide a full set of alphanumeric keys. In addition to providing input, the user input interface may be used, for example, to activate or deactivate certain functions, such as screen savers, sleep modes, and/or the like.

### IV. EXAMPLE SYSTEM OPERATIONS

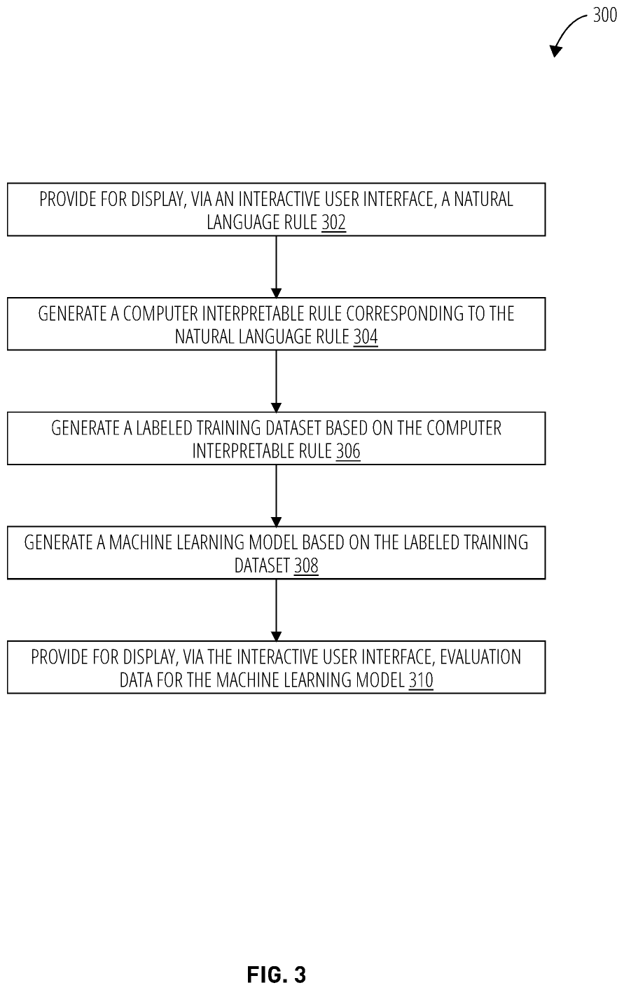

FIG. 3 is a flowchart showing an example of a process 300 for generating a machine learning model based on natural language text in accordance with some embodiments discussed herein. The flowchart depicts a framework for facilitating the generation of a predictive machine learning model through an interactive user interface. The interactive user interface may be implemented by one or more computing devices, entities and/or systems described herein. For example, via the various steps/operations of the process 300, the computing system 100 may leverage the interactive user interface to overcome the various limitations with conventional techniques for developing machine learning models that (i) lack approachability and transparency and (ii) cannot be easily modified based on changing performance conditions.

FIG. 3 illustrates an example process 300 for explanatory purposes. Although the example process 300 depicts a particular sequence of steps/operations, the sequence may be altered without departing from the scope of the present disclosure. For example, some of the steps/operations depicted may be performed in parallel or in a different sequence that does not materially impact the function of the process 300. In other examples, different components of an example device or system that implements the process 300 may perform functions at substantially the same time or in a specific sequence.

The process 300 includes, at step/operation 302, providing for display, via an interactive user interface, a natural language rule. For example, the computing system 100 may provide for display, via the interactive user interface, a natural language rule including natural language text indicative of a performance condition for a machine learning model. The computing system 100, for example, may provide an interactive user interface that includes a text interface for generating, modifying, and/or displaying a natural language rule.

The interactive user interface may include an interface configured to display user interpretable information to a user of the interface and/or receive user input from the user. The user interpretable information may be associated with one or more rules, performance conditions, functions, evaluations, and/or any other information related to a machine learning model. As one example, the user interpretable information may include one or more natural language rules that describe performance conditions for a machine learning model. As another example, the user interpretable information may include evaluation data that describes one or more outputs and/or performance metrics for the machine learning model. By presenting such data to a user, the interactive user interface may facilitate the intelligent design and generation of a machine learning model using natural language.

The interactive user interface may include artificial intelligence mechanisms for assisting a user in the development of a machine learning model by enabling the creation of new natural language rules and/or modifications to existing natural language rules. For instance, the interactive user interface may be configured to receive (e.g., through one or more input devices such keyboards, microphones, and/or the like) user input from a user that describes one or more performance conditions for a machine learning model. As one example, the user input may include natural language text input from the user that describes the performance condition in natural language (e.g., plain English, and/or the like). As another example, the natural language text input may describe a rule modification to an existing natural language rule intended to cover the performance condition.

The artificial intelligence mechanisms may be deployed on the front-end (e.g., client side) such as through the interactive user interface itself (e.g., on the browser, computer application, and/or the like). In addition, or alternatively, the artificial intelligence mechanisms may be deployed on the front-end may be deployed on the back-end (e.g., server side) of the interactive user interface (e.g., on a connected server, cloud platform, and/or the like).

The artificial intelligence mechanisms of the interactive user interface may be configured to analyze natural language text input by the user to provide one or more insights for assisting the generation/modification of a natural language rule to cover a performance condition. In some embodiments, the interactive user interface leverages natural language interpretation functionalities (e.g., natural language models, and/or the like) to identify and emphasize rule attributes represented by the natural language text of a natural language rule that may be instructive for training a machine learning model. For instance, the interactive user interface may assign a real time label to an identified rule attribute of a natural language rule and provide a visual representation of the real time label to the user. By doing so, the interactive user interface may facilitate an understanding of a natural language text's potential impact to a machine learning model in real time as the text is provided by the user. The interactive user interface may receive labeling input for the real time label to confirm and/or modify the real time label. For instance, in the event that a user disagrees with a real time label, the labeling input may include a label modification to improve the interactive user interface's interpretation of the natural language text. In some embodiments, such modifications are used to improve the natural language interpretation functionalities (e.g., machine learning natural language models, and/or the like) leveraged by the interactive user interface.

The interactive user interface may further provide evaluation data for a machine learning model that is trained, using the techniques described herein, based on natural language rules provided by a user. The evaluation data may illustrate the relative performance of the machine learning model as natural language rules are provided to the interactive user interface.

This may allow the user to track the progress of the machine learning model as new performance conditions are introduced through natural language text over a number of training iterations.

In this way, the interactive user interface may enable a user to efficiently and effectively convert a concept with one or more conceptual performance conditions into a machine learning model using natural language text. In addition, the interactive user interface may be utilized to easily and accurately improve and/or update existing machine learning models in the event performance conditions change. Moreover, the interactive user interface may seamlessly automate the transition from legacy rule-based approaches to machine learning models.

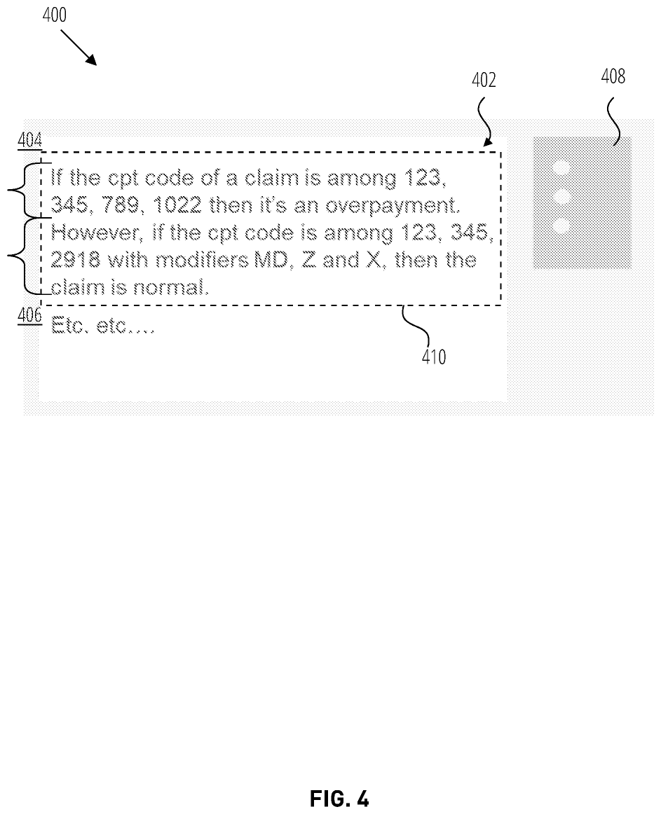

FIG. 4 depicts an operational example 400 of an interactive user interface in accordance with some embodiments discussed herein. The interactive user interface may include a text interface 402 that may display natural language text to a user. In addition, or alternatively, the interactive user interface may include one or more contextual widgets 408 for defining one or more contextual attributes for a machine learning model. The contextual widgets 408, for example, may include one or more interactive widgets that allow a user to select between one or more different development domains (e.g., FWAE domain, and/or the like), training datasets, rule databases, versions, and/or any other contextual attribute that may define one or more aspects of a machine learning model.

The natural language text may include natural language text input 410 provided by the user. In addition, or alternatively, the natural language text may be received and/or converted from a rule database. The natural language text may form one or more natural language rules including, for example, a first natural language rule 404 and a second natural language rule 406. The natural language rules may be input by the user, modified from a previous natural language rule input by the user, and/or converted from a rule of a different format (e.g., a computer interpretable rule, a structured language rule, and/or the like).

A natural language rule may include a data entity that describes a user interpretable rule corresponding to a performance condition for a machine learning model. The natural language rule may include natural language text. For example, the natural language text may include a sequence of natural language words, phrases, and/or the like. The natural language text, for example, may include a series of sentences describing one or more performance conditions for a machine learning model. In some embodiments, a natural language rule includes a sentence that describes a performance condition for a machine learning model. The natural language text may include plain language (e.g., plain English, and/or the like) written, typed, and/or provided according to a linguistic structure governing the plain language. The plain language may include any language interpretable by a human such as natural English language.

The interactive user interface can be leveraged to generate any type of machine learning model based on a plurality of natural language rules. In some embodiments, the machine learning model includes a predictive machine learning model. The predictive machine learning model may include a data entity that describes parameters, hyper-parameters, and/or defined operations of a machine learning model (e.g., model including at least one of one or more rule-based layers, one or more layers that depend on trained parameters, coefficients, and/or the like). The predictive machine learning model may be trained to perform a classification, prediction, and/or any other computing task. The predictive machine learning model may include one or more of any type of machine learning model including one or more supervised, unsupervised, semi-supervised, and/or reinforcement learning models. In some embodiments, the predictive machine learning model includes multiple models configured to perform one or more different stages of a classification, prediction, and/or the like computing task.

As one example, a predictive machine learning model may include a classification model trained, using one or more semi-supervised and/or supervisory training techniques, to output a classification output predicted to correspond to an input data object. The classification output, for example, may include a discrete value output for a particular input data object. In some embodiments, the predictive machine learning model is trained using a labeled training dataset that includes a plurality of synthetic and/or historical input data objects with a plurality of labels identifying ground truth classifications respectively corresponding to the plurality of synthetic and/or historical input data objects.

The predictive machine learning model, the classification output, and/or the input data object may each depend on the use case. As one example use case provided for illustration purposes only, the interactive user interface may be applied to a medical claim verification process in which a medical claim may be approved or denied based on a plurality of constantly changing business, policy, and/or contractual conditions. In such a case, the predictive machine learning model may include a fraud waste abuse and error (FWAE) model, the input data object may include a medical claim, and the classification output may include a predictive classification indicative of whether the claim should be denied or approved. The machine learning FWAE model may be trained using a labeled training dataset with a plurality of claims that are labeled according to performance conditions for a specific business entity.

A performance condition for the predictive machine learning model may include a data entity that describes a desired condition for the predictive machine learning model. A performance condition may be based on criteria for evaluating an input to the predictive machine learning model such that the type, number, and/or substance of performance conditions for the predictive machine learning model may depend on the use case for the machine learning model. As one example use case, the predictive machine learning model may include an FWAE model utilized to verify medical claims. In such a case, a performance condition may be based on criteria for evaluating a medical claim such as business policies and/or contracts, medical trends, treatment efficacy research, industry standards, and/or the like. The criteria for evaluating a medical claim may be complex, complicated, and may dynamically change based on an entity's business relationships and/or ongoing research/best practices. Typically, performance conditions based on such criteria may rely on domain knowledge shared among Subject Matter Experts (SMEs) in the field. As businesses transform, the performance conditions may be adapted to accommodate for changing criteria.

In some embodiments, each respective natural language rule corresponds to a respective performance condition for the predictive machine learning model. For example, the first natural language rule 404 may correspond to a first performance condition, the second natural language rule 406 may correspond to a second performance condition, and/or the like. The first performance condition may be different from the second performance condition.

In some embodiments, a natural language rule is selected from a rule database associated with a plurality of predictive models. The rule database may include a data entity that describes a plurality of rules for one or more predictive models. The rule database may include any type of data structure including, as examples, one or more relational databases, knowledge graphs, hierarchical databases, network databases, object-oriented databases, NoSQL databases, and/or the like. The rules may include a plurality of natural language rules, a plurality of computer interpretable rules, a plurality of structured language rules, and/or the like. The rule database may include one or more rule associations that may identify one or more correlations between the rules. By way of example, each rule association may respectively describe an associated set of rules. A rule association, for example, may identify at least a computer interpretable rule corresponding to a respective natural language rule. A computer interpretable rule, for example, may be stored in the rule database in association with a corresponding natural language rule.

In some embodiments, the rule database includes contextual data for at least one rule (e.g., natural language rule, computer interpretable rule, structured language rule, and/or the like). The contextual data may identify one or more contextual attributes for the rule such as a number and/or model characteristics of one or more predictive models that are associated (e.g., defined by, trained using, and/or the like) with the rule, a performance condition corresponding to the rule, an age and/or developer of the rule, and/or the like.

In some embodiments, a user accesses a rule database for a particular domain, using the contextual widgets 408, to view and/or select one or more natural language rules based on the desired performance conditions for the predictive machine learning model. Each natural language rule may be selected based on the user's interpretation of the natural language text describing the rule. In this way, a user may efficiently review a plurality of natural language rules based on user interpretable information.

Turning back to FIG. 3, the process 300 includes, at step/operation 304, generating a computer interpretable rule corresponding to the natural language rule. For example, the computing system 100 may generate, using a natural language model, a computer interpretable rule corresponding to the natural language rule based on the natural language text. The computer interpretable rule may include a labeling function that corresponds to the performance condition.

A computer interpretable rule, for example, may include a data entity that describes a computer interpretable constraint corresponding to a performance condition. In some embodiments, the computer interpretable rule includes a labeling function generated for a performance condition. Using some of the techniques described herein, the computer interpretable rule may be generated based on a natural language rule and/or a structured language rule. In some embodiments, the computer interpretable rule includes a segment of program code that is executable to perform a labeling function for a training dataset. The computer interpretable rule may be generated based on a computer-interpretable template and/or one or more rule attributes. In some embodiments, the computer interpretable rule is generated using natural language processing model architectures (e.g., transformers, and/or the like) that automatically generate templates based on certain input criteria.

The computing system 100 may generate the computer interpretable rule based on one or more rule attributes and/or a computer interpretable template corresponding to a natural language rule.

A rule attribute may include a data entity that describes a portion of information that may be relevant for a constraint corresponding to a performance condition. In some embodiments, a rule attribute is extracted from a natural language rule and/or a structured language rule. A rule attribute, for example, may correspond to a portion of text from a natural language rule and/or a portion of code from a structured language rule. In some embodiments, the extracted rule attributes are leveraged to augment a corresponding computer interpretable template to generate a computer interpretable rule.

A computer interpretable template may include a data entity that describes a predefined template for generating a computer interpretable rule based on one or more rule attributes. The computer interpretable template may include a segment of program code that is modifiable to account for the rule attributes. By way of example, the segment of program code may include an executable if-then statement. The segment of program code may be implemented in assembly languages, programming languages, such as Python, Java, C, and/or the like. In some embodiments, a computer interpretable template is selected from a plurality of computer interpretable templates based on one or more rule attributes. By way of example, the computer interpretable templates may include a respective computer interpretable template for each of a plurality of different types and/or combinations of rule attributes. In addition, or alternatively, in some embodiments, the computer interpretable template is based on a domain. For example, a respective computer interpretable template may be selected based on a domain associated with the predictive machine learning model.

The rule attributes and/or computer interpretable template may depend on the use case. In one example use case, the predictive machine learning model may include an FWAE model utilized to verify medical claims. In such a case, the rule attributes may include portions of information that may be relevant for enforcing a performance condition for verifying medical claims. Such attributes may include, as examples, current procedural terminology (CPT) codes, code modifiers, target diagnoses, and/or the like.

The computing system 100 may identify one or more rule attributes from a natural language rule using one or more natural language processing techniques. For instance, the computing system 100 may identify, using a natural language model, the rule attributes from the natural language text of a natural language rule.

The natural language model may include a data entity that describes parameters, hyper-parameters, and/or defined operations of a rule-based and/or machine learning model (e.g., model including at least one of one or more rule-based layers, one or more layers that depend on trained parameters, coefficients, and/or the like). The natural language model may include one or more of any type of rule-based and/or machine learning model including one or more supervised, unsupervised, semi-supervised, and/or reinforcement learning models. In some embodiments, a natural language model includes multiple models configured to perform one or more different stages of a natural language processing task.

As one example, a machine learning natural language model may include a natural language processor trained to identify rule attributes from natural language text forming one or more natural language rules. The machine learning natural language model may include any type of natural language processor including, as examples, support vector machines, Bayesian networks, maximum entropies, conditional random fields, neural networks, transformers, and/or the like. For example, the machine learning natural language model may include a name entity recognition model.

In some embodiments, the interactive user interface deploys a natural language model to generate real time feedback for a user based on the rule attributes identified for a natural language rule.

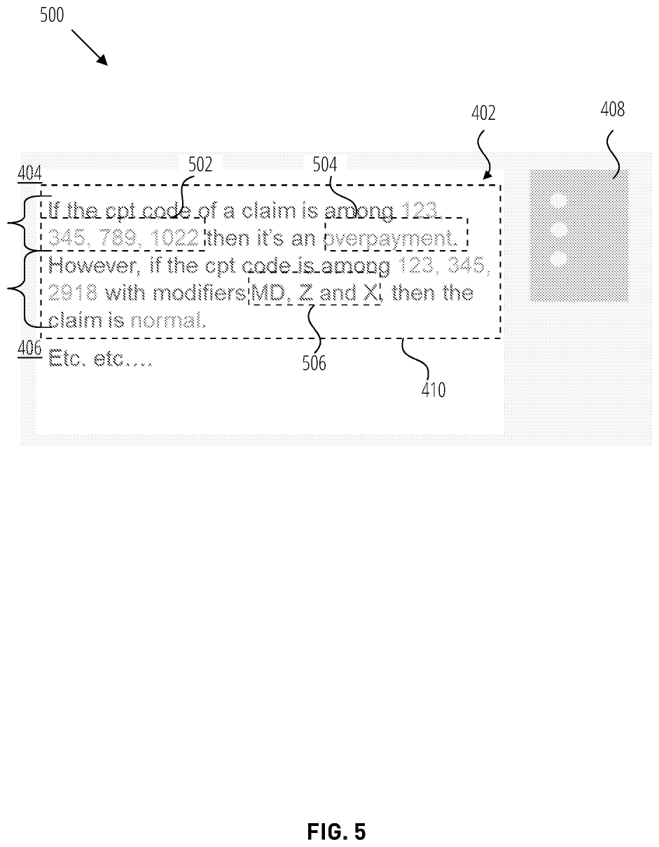

FIG. 5 depicts an operational example 500 of the interactive user interface in accordance with some embodiments discussed herein. In some embodiments, the interactive user interface includes one or more interactive tools to assist a user in the development of a natural language rule. The interactive tools may be implemented to enable a user to convert an abstract concept into an actionable insight using well defined natural language rules to ultimately form a machine learning model. The interactive user interface, for example, may include and/or access a natural language model that may be leveraged to highlight, in real time, important sections of a natural language rule as a user provides natural language text input 410 to the interactive user interface.

For example, the interactive user interface may apply the natural language model to natural language text to generate one or more real time labels for the natural language rule. A real time label may include a data entity that describes a characteristic of a rule attribute. A real time label, for example, may identify a type of rule attribute and/or one or more other insights into how the rule attribute may be used to generate a computer interpretable rule. By way of example, a computer interpretable template may include a plurality of modifiable locations in which certain types of rule attributes may be placed. A real time label may identify where a rule attribute may be placed within a computer interpretable template. As one example, a computer interpretable template may include a first modifiable location designated for rule attributes of a first type (e.g., CPT codes in an FWAE use case), a second modifiable location designated for rule attributes of a second type (e.g., modifier codes in an FWAE use case), and/or a third modifiable location designated for rule attributes of a third type (e.g., target diagnoses in an FWAE use case).

In some embodiments, a real time label includes a sensory indicator (e.g., visual, auditory, and/or the like). By way of example, a real time label may include one or more visual identifiers. A real time label, for example, may correspond to a portion of natural language text and/or structured language text that corresponds to a respective rule attribute. A visual identifier may include a modification to the text color, font, background color, and/or the like associated with the portion of natural language text and/or structured language text. In some embodiments, a portion of natural language text and/or structured language text is modified to include the visual identifier (e.g., by changing a text color, font, background color, and/or the like).

The real time labels, for example, may include a first real time label 502 indicative of a rule attribute of a first type present in the first natural language rule 404, a second real time label 504 indicative of a rule attribute of a second type present in the first natural language rule 404, a third real time label 506 indicative of a rule attribute of a third type present in the second natural language rule 406. Each of the real time labels may be associated with a different sensory indicator (e.g., color, tone, and/or the like) to differentiate between each type of labeled attribute.

In some embodiments, the computing system 100 generates a real time label for at least one rule attribute of the rule attributes and modify, via the interactive user interface, the natural language text of a natural language rule to identify the real time label to the user in real time.

In some embodiments, the real time label is interactive. For instance, the computing system 100 may receive, via the interactive user interface, labeling input for a natural language rule. The labeling input may include a selection of an interactive real time label. In addition, or alternatively, the labeling input may include a selection of unlabeled natural language text. In some embodiments, the labeling input is provided using the contextual widgets 408.

The labeling input may include label modification, a label verification, and/or a contextual label information for a real time label. A label modification, for example, may indicate a different real time label for a labeled natural language segment. In response to receiving the label modification, the computing system 100 may modify the at least one rule attribute corresponding to the real time label based on the label modification. In some embodiments, the label modification is utilized as ground truth data for training the natural language model.

The computing system 100 may generate a computer interpretable rule for a natural language rule based on one or more identified rule attributes and a computer interpretable template. In some embodiments, the computing system 100 identifies a computer interpretable template corresponding to the rule attributes of the natural language rule and, in response, the computing system 100 may augment the computer interpretable template with the rule attributes to generate the computer interpretable rule.

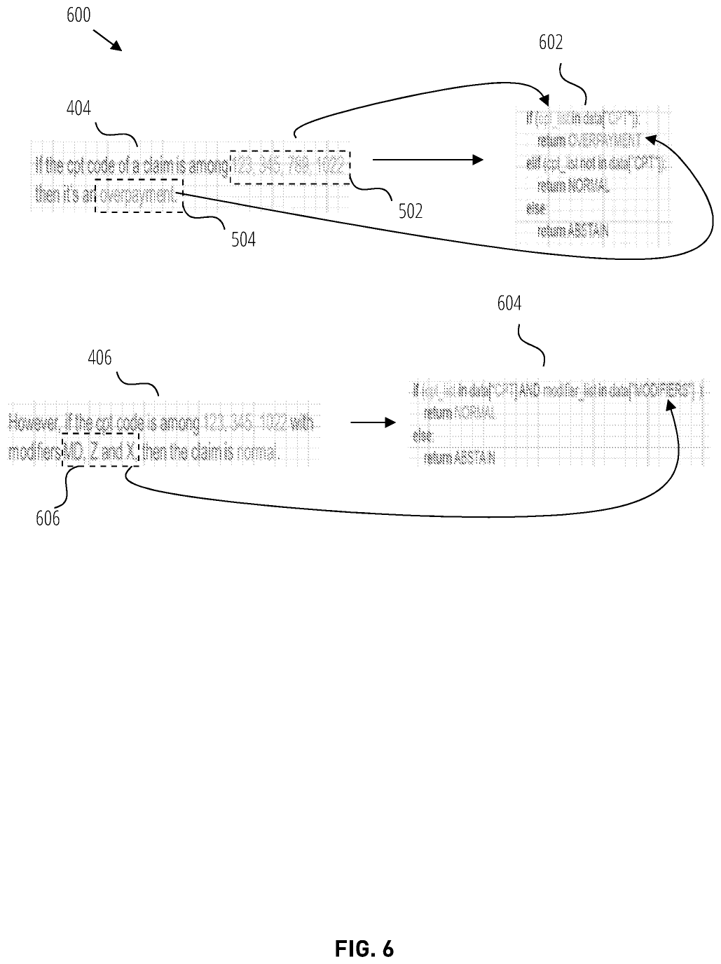

FIG. 6 depicts an operational example 600 of natural language rules and computer interpretable rules in accordance with some embodiments discussed herein. The natural language rules include the first natural language rule 404 and the second natural language rule 406. The first natural language rule 404 corresponds to a first computer interpretable rule 602. The second natural language rule 406 corresponds to second computer interpretable rule 604.

The first computer interpretable rule 602 may include a computer interpretable template augmented with one or more rule attributes from the first natural language rule 404. By way of example, the first natural language rule 404 may include a first real time label 502 indicative of a first rule attribute of a first type (e.g., a list of codes for a FWAE use case). The first real time label 502 may be leveraged to augment a corresponding portion of the computer interpretable template with the rule attribute. As another example, the first natural language rule 404 may include a second real time label 504 indicative of a second rule attribute of a second type (e.g., a target diagnosis for a FWAE use case). The second real time label 504 may be leveraged to augment another corresponding portion of the computer interpretable template with the rule attribute to generate the first computer interpretable rule 602.

The second computer interpretable rule 604 may include a computer interpretable template augmented with one or more rule attributes from the second natural language rule 406. By way of example, the second natural language rule 406 may include a third real time label 506 indicative of a third rule attribute of a third type (e.g., a list of modifiers for a FWAE use case). The third real time label 506 may be leveraged to augment a corresponding portion of another computer interpretable template with the rule attribute to generate the second computer interpretable rule 604.

In some embodiments, the computing system 100 stores the computer interpretable rules in association with the natural language rules in the rule database. For example, the computing system 100 may store the first natural language rule 404 and the first computer interpretable rule 602 in the rule database. In addition, or alternatively, the computing system 100 may store the second natural language rule 406 and the second computer interpretable rule 604 in the rule database. Each may be stored as an associated rule pair. For instance, the first natural language rule 404 and the first computer interpretable rule 602 may be stored in a first rule data structure corresponding to a first performance condition. In addition, or alternatively, the second natural language rule 406 and the second computer interpretable rule 604 may be stored in a second rule data structure corresponding to a second performance condition. A rule data structure, for example, may include each of a plurality of rule types (e.g., natural language rules, computer interpretable rules, structured language rules, and/or the like) for a performance condition. In some embodiments, a rule data structure further includes contextual data for a respective rule.

Turning back to FIG. 3, the process 300 includes, at step/operation 306, generating a labeled training dataset based on the computer interpretable rule. For example, the computing system 100 may generate, using a weak supervision model, a labeled training dataset based on the computer interpretable rule.

The weak supervision model may include a data entity that describes parameters, hyper-parameters, and/or defined operations of a rules-based model and/or a machine learning model (e.g., model including at least one of one or more rule-based layers, one or more layers that depend on trained parameters, coefficients, and/or the like). The weak supervision model may include a weakly supervised machine learning model configured to label an unlabeled training dataset using one or more labeling functions. The machine learning weak supervision model may include one or more classical and/or deep learning based techniques configured to jointly apply (e.g., identify/resolve dependencies between, and/or the like) a plurality of labeling rules to an unlabeled training dataset to generate a labeled training dataset. The computing system 100 may receive at least a portion of an unlabeled training dataset and apply the weak supervision model to the at least one portion the unlabeled training dataset to generate the labeled training dataset.

An unlabeled training dataset, for example, may include a data entity that describes a plurality of at least partially unlabeled input data objects for one or more predictive models. An unlabeled training dataset may include and/or be stored in any type of data structure including, as examples, one or more relational databases, knowledge graphs, hierarchical databases, network databases, object-oriented databases, NoSQL databases, and/or the like. An unlabeled training dataset may describe a plurality of unlabeled synthetic and/or historical input data objects for one or more predictive models. The unlabeled input data objects may be based on the use case. In one example, for an FWAE use case, the unlabeled input data objects may include unprocessed medical claims without an indication of whether the medical claim is approved (e.g., is normal) or denied (e.g., is associated with an overpayment).

The labeled training dataset may include a data entity that describes a plurality of labeled input data objects for one or more predictive models. A labeled training dataset may include and/or be stored in any type of data structure including, as examples, one or more relational databases, knowledge graphs, hierarchical databases, network databases, object-oriented databases, NoSQL databases, and/or the like. A labeled training dataset may describe a plurality of labeled synthetic and/or historical input data objects for one or more predictive models. The labeled input data objects may be based on the use case. In one example, for an FWAE use case, the labeled input data objects may include processed medical claims with a label identifying whether the medical claim is approved, denied, and/or any other information/classification. In addition, or alternatively, the labeled input data object may include regression-based labels that include a percentage, ratio, and/or a range of numbers.

The process 300 includes, at step/operation 308, generating a machine learning model based on the labeled training dataset. For example, the computing system 100 may generate a machine learning model based on the labeled training dataset using one or more supervised and/or semi-supervised training techniques such as back-propagation of errors and/or the like.

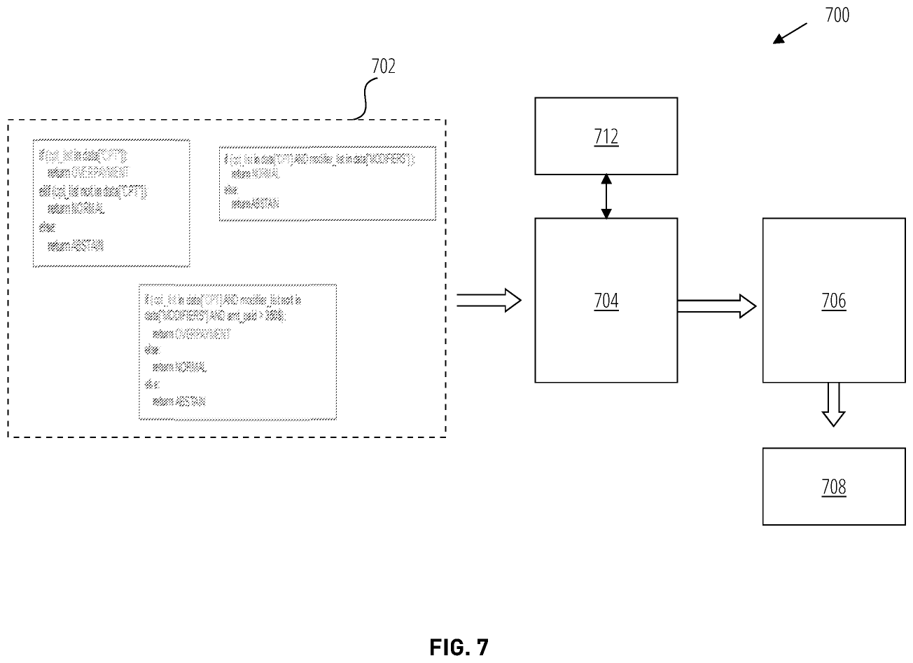

FIG. 7 depicts an operational example 700 for generating a machine learning model using weak supervision techniques in accordance with some embodiments discussed herein. A predictive machine learning model 708 may be generated, using a weak supervision model 704 and a training model 706, based on a set of labeling functions 702. By way of example, the set of labeling functions 702 may be provided to a weak supervision model 704. The weak supervision model 704 may apply the set of labeling functions 702 to an unlabeled training dataset 712 to generate a labeled training dataset with labels that align with each of the set of labeling functions 702. The labeled training dataset may be provided to the training model 706. The training model 706 may train the predictive machine learning model 708 using one or more semi-supervised and/or fully supervised training techniques to optimize the predictive machine learning model 708 for one or more performance conditions covered by the set of labeling functions 702. Once optimized, the predictive machine learning model 708 may be output for evaluation.

Turning back to FIG. 3, the process 300 includes, at step/operation 310, providing for display, via the interactive user interface, evaluation data for the machine learning model. For example, the computing system 100 may provide for display, via the interactive user interface, evaluation data for the machine learning model. The evaluation data may describe a performance of the predictive machine learning model. The performance of the predictive machine learning model may be based on outputs of the model and/or performance metrics for the model. The evaluation data, for example, may include a plurality of training outputs for the predictive machine learning model, one or more performance metrics for the predictive machine learning model, and/or any other information representative of the performance of the predictive machine learning model. In some embodiments, the computing system 100 generates the evaluation data for the machine learning model based on the training outputs, the performance metrics, and/or the like. The evaluation data, for example, may be indicative of an association between a natural language rule and the training outputs and/or the performance metrics.

By way of example, the computing system 100 may generate one or more training outputs for the predictive machine learning model. The training outputs, for example, may include a component of the evaluation data. The training outputs for a predictive machine learning model may include a plurality of outputs generated by the predictive machine learning model based on a training dataset. The training outputs may be generated during an iteration of an iterative model training process in which one or more rules are modified and/or added for consideration of the machine learning model during each iteration. The training output may be analyzed individually and/or in one or more combinations to assess an impact of one or more modified and/or added rules on the outputs of the predictive machine learning model. In this way, the training outputs may help a user verify an efficacy of a natural language rule and/or converge to a final concept defined by a plurality of natural language rules.

As another example, the computing system 100 may generate, using the machine learning model, one or more performance metrics for the machine learning model. The performance metrics, for example, may be based on the training outputs. For example, the performance metrics may include another component of the evaluation data. The performance metrics for a predictive machine learning model may include one or more metrics (e.g., false positive rate, false negative rate, precision, recall, AUC, etc.) for the predictive machine learning model based on the training outputs. The performance metrics may be analyzed individually and/or in one or more combinations to assess an impact of one or more modified and/or added rules on the performance of the predictive machine learning model. In this way, the performance metrics may allow a user to track a progress of the predictive machine learning model as rules are added/modified/converted at each iteration of an iterative model training process. In some embodiments, a performance metric represents a performance of the predictive machine learning model with respect to a previous model.

In some embodiments, the interactive user interface is leveraged to perform an iterative model training process to generate a predictive machine learning model. By way of example, one or more of the steps/operations of the process 300 may be performed during an iteration of the iterative model training process to generate and/or refine a machine learning model.

For example, during a first iteration of the iterative model training process, one or more first iteration natural language rules may be received (e.g., from a user, rule database, and/or the like), one or more first iteration computer interpretable rules may be generated for the first iteration natural language rules, a first iteration labeled training dataset may be generated using the first iteration computer interpretable rules, a first iteration predictive machine learning model may be generated using the first iteration labeled training dataset, and evaluation data for the first iteration predictive machine learning model may be generated and displayed to a user. A second iteration of the iterative model training process may be performed based on the evaluation data, one or more performance requirements for the machine learning model, one or more user preferences, and/or the like.

During a second iteration of the iterative model training process, one or more second iteration natural language rules may be received (e.g., from a user, rule database, and/or the like). The second iteration natural language rules may include one or more natural language rules in addition to the first iteration natural language rules and/or one or more modified versions of the first iteration natural language rules. The steps from the first iteration may then be performed for a second iteration using the second iteration natural language rules. This iterative model training process may continue until the predictive machine learning model achieved one or more performance criteria.

At each iteration, a new predictive machine learning model may be generated based on a plurality of natural language rules. In some embodiments, the evaluation data provided at the conclusion of an iteration is indicative of a relative performance of the predictive machine learning model relative to a previous model generated without one or more of the natural language rules. In this way, the evaluation data may provide insights on the relative impact of a natural language rule to the performance the predictive machine learning model.

A previous model, for example, may include a data entity that describes parameters, hyper-parameters, and/or defined operations of a machine learning model (e.g., model including at least one of one or more rule-based layers, one or more layers that depend on trained parameters, coefficients, and/or the like) and/or any other algorithm. As used herein, the previous model may include a previous version of a predictive machine learning model generated in a previous iteration of the iterative model training process. In addition, or alternatively, the previous model may include a previously deployed machine learning model that is being modified through the iterative model training process to account for one or more performance condition changes. As another example, the previous model may include a rules-based model previously configured to output similar outputs of the predictive machine learning model.

In some embodiments, at an iteration of the iterative model training process, a natural language text input is received, via the interactive user interface, that includes a rule modification to an existing natural language rule (e.g., previously input by a user, received from a rule database, converted from a structured language rule, and/or the like). The rule modification may be based on the evaluation data and/or any other factor that may inform help to improve the performance of the predictive machine learning model.

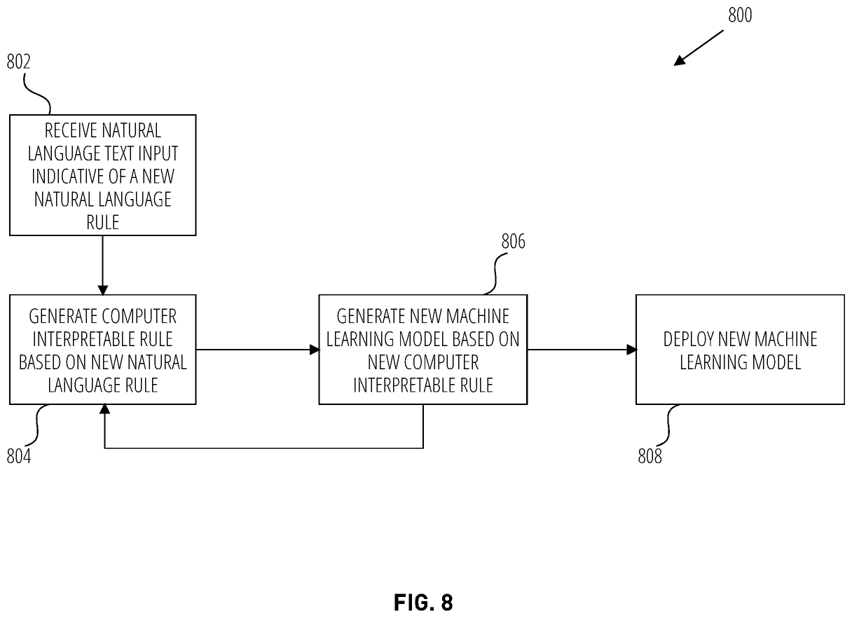

FIG. 8 depicts an operational example 800 of an iterative model training process in accordance with some embodiments discussed herein. The operational example 800 depicts a framework for facilitating the generation of a new predictive machine learning model from a conceptual, unimplemented theory. Via the various steps/operations of the operational example 800, the computing system 100 may leverage an interactive user interface to overcome the various limitations with conventional techniques for developing new machine learning models by enabling the creation of the models in a controlled environment using natural language rules.

The operational example 800 may include receiving, at step/operation 802, natural language text input indicative of a new natural language rule. The computing system 100 may receive the natural language text input from a user through a text interface of the interactive user interface. The natural language text input may describe, in natural language terms and structure, a list of desired performance conditions for a new concept of the user. As the user interacts with the interactive user interface to provide the natural language text input, the interactive user interface may provide feedback regarding one or more natural language rules such as one or more real time labels, one or more rule suggestions, and/or the like. In this way, the interactive user interface may aid a user in converting a concept into actionable insights to form a machine learning model. As described herein, the interactive user interface may be configured to identify rule attributes in real time, assign real time labels to the rule attributes, and provide an indication of the real time labels to the user to highlight important portions a natural language rule based on the provided natural language text input. In addition, or alternatively, the interactive user interface may map data characteristics regarding the intended domain (e.g., a prediction domain, business domain, and/or the like) of the machine learning model to the real time labels and provide the data characteristics to the user as additional feedback.

The operational example 800 may include generating, at step/operation 804, a computer interpretable rule based on the new natural language rule. The computing system 100 may generate a different computer interpretable rule based on each natural language rule identified from the natural language text input using the techniques described herein. In this way, the interactive user interface may facilitate the conversion of a user's input into computer interpretable rules that may be used as a labeling function for training a machine learning model.

The operational example 800 may include generating, at step/operation 806, a new machine learning model based on the new computer interpretable rules generated in the step/operation 804. The new machine learning model may include an initial machine learning model generated using a weakly supervised learning (or semi-supervised) machine learning algorithm. The new machine learning model may be evaluated based on one or more training outputs generated by the new machine learning model. Evaluation data indicative of the performance of the new machine learning model may be provided to the user. And, the user may determine whether to perform another iteration of an iterative model training process based on the evaluation data. In this way, through one or more iterations of the iterative model training process, the user may converge on a final well-defined concept that is governed by a plurality of refined natural language rules.

The operational example 800 may include deploying, at step/operation 808, the new machine learning model after one or more iterations of the iterative model training process. In some embodiments, the new machine learning model is provided to a second user (e.g., a data scientist, and/or the like) to further verify the performance of the model. For instance, the computing system 100 may provide the new machine learning model, a list of natural language rules and computer interpretable rules used to generate the new machine learning model, and/or any other data related to the model to the second user for evaluation.

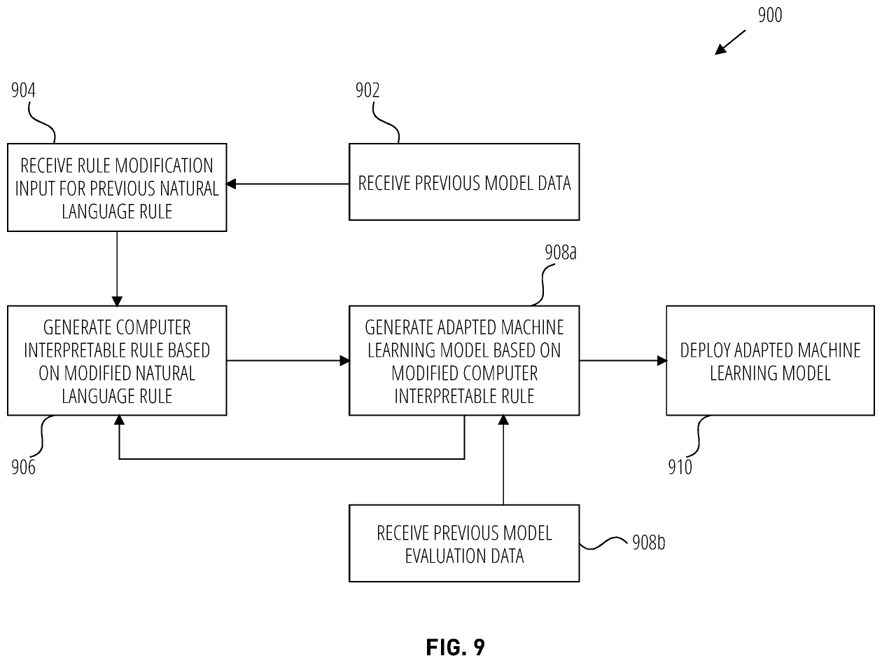

FIG. 9 depicts an operational example 900 of an iterative model training process in accordance with some embodiments discussed herein. The operational example 900 depicts a framework for facilitating the adaptation of an existing machine learning model to accommodate one or more different performance conditions. Via the various steps/operations of the operational example 900, the computing system 100 may leverage an interactive user interface to overcome the various limitations with conventional techniques for adapting existing machine learning models by enabling the adaptation of the models in a controlled environment using modifications to natural language rules.

The operational example 900 may include receiving, at step/operation 902, previous model data. The computing system 100 may receive the previous model data from a rule database, one or more remote datastores (e.g., from one or more external computing entity 112a-c, and/or the like), the user, and/or any other data source. The previous model data may include any information associated with an existing machine learning model. For example, the previous model data may describe one or more rules (e.g., natural language rules, computer interpretable rules, and/or the like) used to generate the previous model. In addition, or alternatively, the previous model data may describe one or more performance conditions, domain characteristics, (e.g., lists of CPT codes analyzed in a FWAE use case), and/or any other knowledge related to the previous model.

The operational example 900 may include receiving, at step/operation 904, a rule modification input for previous natural language rule at step/operation 904. The computing system 100 may receive natural language text input from a user through a text interface of the interactive user interface that is indicative of the rule modification.

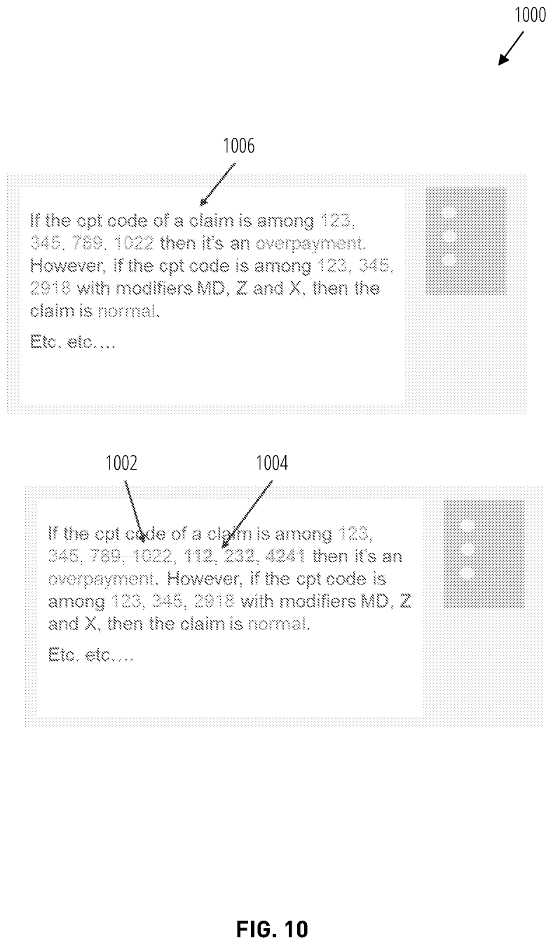

FIG. 10 depicts an operational example 1000 of a rule modification to a natural language rule via an interactive user interface in accordance with some embodiments discussed herein. A rule modification may be provided by modifying the natural language text 1006 of a natural language rule. For instance, the interactive user interface may be configured to provide natural language text 1006 for one or more different natural language rules for display via an interactive text interface. The different natural language rules may include one or more natural language rules previously provided by the user (e.g., during a previous iteration of an iterative model training process, and/or the like), one or more natural language rules corresponding to computer interpretable rules previously used to generate an existing machine learning model, one or more natural language rules converted from structured language rules, and/or the like. A rule modification may include one or more additions 1004 and/or deletions 1002 to the natural language text 1006 to modify the meaning of the natural language rule, for example, to refine the natural language rule, to cover a modified performance condition, and/or the like.

In this way, the computing system 100 may receive, via the interactive user interface, natural language text input for a natural language rule that includes a rule modification to the natural language rule. In some embodiments, the rule modification is provided to adapt an existing machine learning model to accommodate for one or more different performance conditions. The rule modification may also be used to refine a previously provided natural language rule and/or, as described herein, modify a converted natural language rule.

Turning back to FIG. 9, the operational example 900 may include generating, at step/operation 906, a computer interpretable rule based on the modified natural language rule. The computing system 100 may scan a list of natural language rules to identify one or more modified natural language rules, one or more deleted natural language rules, and/or one or more new natural language rules for a machine learning model. A new/modified computer interpretable rule may be generated based on a new/modified natural language rule using the techniques described herein to generate a new set of labeling functions for training the machine learning model.

The operational example 900 may include generating, at step/operation 908a, a machine learning model based on the modified computer interpretable rules generated in the step/operation 906. The machine learning model may include an adapted machine learning model generated using a weakly supervised learning (or semi-supervised) machine learning algorithm to accommodate for one or more new and/or changing performance conditions. The adapted machine learning model may be evaluated based on one or more training outputs generated by the adapted machine learning model. Evaluation data indicative of the performance of the adapted machine learning model may be provided to the user. And, the user may determine whether to perform another iteration of an iterative model training process based on the evaluation data.

In some embodiments, the operational example 900 includes receiving, at step/operation 908b, evaluation data for the previous model. For example, the evaluation data for the previous model may be indicative of one or more performance metrics and/or training outputs for the previous model. The evaluation data generated for the adapted machine learning model may be compared to the previous evaluation data for the previous model to illustrate a relative performance of the adapted machine learning model relative to the previous model. In this way, a user may continually track improvements and/or degradations between two versions of a machine learning model.

The operational example 900 may include deploying, at step/operation 910, the adapted machine learning model at step/operation 910. In some embodiments, the adapted machine learning model is provided to a second user (e.g., a data scientist, and/or the like) to further verify the performance of the model. For instance, the computing system 100 may provide the adapted machine learning model, a list of natural language rules and computer interpretable rules used to generate the adapted machine learning model, and/or any other data related to the model to the second user for evaluation.

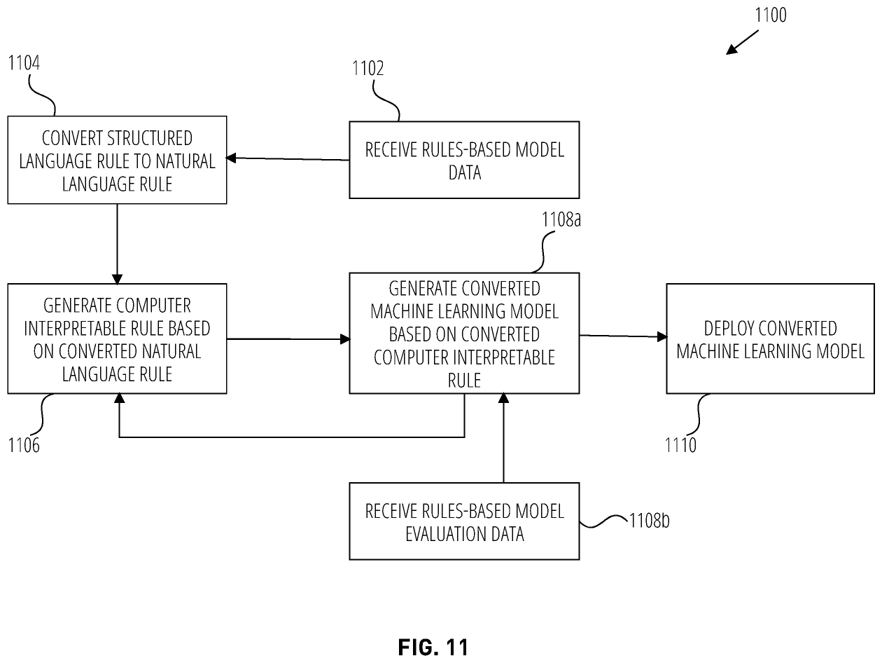

FIG. 11 depicts an operational example 1100 of an iterative model training process in accordance with some embodiments discussed herein. The operational example 1100 depicts a framework for facilitating the conversion of an existing rules-based model to modern machine learning models. Via the various steps/operations of the operational example 1100, the computing system 100 may leverage an interactive user interface to overcome the various limitations with conventional techniques for converting existing machine learning models by using natural language rules as an intermediary between structured language rules and computer interpretable rules used to generate a machine learning model.

The operational example 1100 may include receiving, at step/operation 1102, rules-based model data for an existing rules-based model. The computing system 100, for example, may receive the previous model data from a rule database, one or more remote datastores (e.g., from one or more external computing entity 112a-c, and/or the like), the user, and/or any other data source. The previous model data may include rules-based model data describing one or more components of a rules-based model. A previous model, for example, may include a rules-based model defined by a plurality of structured language rules and/or a rules-based model definition.

For example, a rules-based model may include a data entity that describes parameters, hyper-parameters, and/or defined operations of a rules-based algorithm. A rules-based model may be defined by one or more structured languages. In some embodiments, the rules-based model is defined by one or more hard coded programming scripts, segments of legacy programming languages, SQL procedures/scripts and/or the like. The rules-based model data may describe one or more hard coded rules (e.g., structured language rules, and/or the like) used to generate a predictive output that may be replaced by outputs of a machine learning model. In addition, or alternatively, the rules-based model data may describe one or more performance conditions, domain characteristics, (e.g., lists of CPT codes analyzed in a FWAE use case), and/or any other knowledge related to the rules-based model.

The operational example 1100 may include converting, at step/operation 1104, a structured language rule (e.g., a hard coded rule, and/or the like) to a natural language rule. By way of example, the computing system 100 may apply one or more conversion algorithms (e.g., natural language models, rules-based mapping algorithms, and/or the like) to map one or more segments of a structured language rule to a natural language rule. Natural language text may be provided for display, via the interactive user interface, to a user that represents a natural language rule converted from the structured language rule. A user may interpret the natural language rule and provide one or more rule modifications to refine the converted natural language rule based on the performance conditions for the machine learning model.

The operational example 1100 may include generating, at step/operation 1106, a computer interpretable rule based on the converted natural language rule. For example, the computing system 100 may generate a converted computer interpretable rule for the structured language rule based on the converted natural language rule using the techniques described herein to generate a converted set of labeling functions for training a converted machine learning model. For example, the computing system 100 may generate the converted natural language rule based on a particular structured language rule of a plurality of structured language rules defining a rules-based model. The set of labeling functions for training the converted machine learning model may include a converted computer interpretable rule for each of the structured language rules.

The operational example 1100 may include generating, at step/operation 1108a, a machine learning model based on the converted computer interpretable rule. The machine learning model may include a converted machine learning model generated using a weakly supervised learning (or semi-supervised) machine learning algorithm to accommodate for performance conditions defined by a plurality of structured language rules defining a rules-based model. The converted machine learning model may be evaluated based on one or more training outputs generated by the converted machine learning model. Evaluation data indicative of the performance of the converted machine learning model may be provided to the user. And, the user may determine whether to perform another iteration of an iterative model training process based on the evaluation data.

The operational example 1100 may include receiving, at step/operation 1108b, rules-based model evaluation data. For example, the evaluation data for the rules-based model may be indicative of one or more performance metrics and/or training outputs for the rules-based model. The evaluation data generated for the converted machine learning model may be compared to the rules-based evaluation data for the rules-based model to illustrate a relative performance of the converted machine learning model relative to the rules-based model. In this way, a user may continually track improvements and/or degradations between two versions of a model, one machine learning based and one rules-based, configured to adhere to one or more performance conditions.

The operational example 1100 may include deploying, at step/operation 1110, the converted machine learning model. In some embodiments, the converted machine learning model is provided to a second user (e.g., a data scientist, and/or the like) to further verify the performance of the model. For instance, the computing system 100 may provide the converted machine learning model, a list of natural language rules and computer interpretable rules used to generate the converted machine learning model, and/or any other data related to the model to the second user for evaluation.

### V. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VI. EXAMPLES

Example 1. A computer-implemented method comprising: providing for display, by one or more processors and via an interactive user interface, a natural language rule comprising natural language text indicative of a performance condition for a machine learning model; generating, by the one or more processors and using a natural language model, a computer interpretable rule corresponding to the natural language rule based at least in part on the natural language text, wherein the computer interpretable rule comprises a labeling function that corresponds to the performance condition; generating, by the one or more processors and using a weak supervision model, a labeled training dataset based at least in part on the computer interpretable rule; generating, by the one or more processors, the machine learning model based at least in part on the labeled training dataset; and providing for display, by the one or more processors and via the interactive user interface, evaluation data for the machine learning model.

Example 2. The computer-implemented method of example 1 further comprising: generating, by the one or more processors and using the machine learning model, one or more performance metrics for the machine learning model; and generating, by the one or more processors, the evaluation data for the machine learning model based at least in part on the one or more performance metrics, wherein the evaluation data is indicative of an association between the natural language rule and the one or more performance metrics.

Example 3. The computer-implemented method of example 1 or 2 further comprising receiving, by the one or more processors and via the interactive user interface, natural language text input comprising a rule modification to the natural language rule.

Example 4. The computer-implemented method of example 3 wherein the rule modification is based at least in part on the evaluation data.

Example 5. The computer-implemented method of any of the preceding examples wherein the machine learning model is generated based at least in part on a plurality of natural language rules, wherein the evaluation data is indicative of a relative performance of the machine learning model relative to a previous model generated without the natural language rule.

Example 6. The computer-implemented method of example 5 wherein the previous model is a rules-based model defined by a plurality of structured language rules, and the computer-implemented method further comprises: generating, by the one or more processors, the natural language rule based at least in part on a particular structured language rule of the plurality of structured language rules.

Example 7. The computer-implemented method of any of the preceding examples wherein the natural language rule is selected from a rule database associated with a plurality of predictive models, wherein the rule database comprises data indicative of: (i) a plurality of computer interpretable rules and a plurality of natural language rules, and (ii) one or more rule associations that identify one or more correlations between the plurality of computer interpretable rules and the plurality of natural language rules.

Example 8. The computer-implemented method of example 7 further comprising: storing, by the one or more processors, the computer interpretable rule in association with the natural language rule in the rule database.

Example 9. The computer-implemented method of any of the preceding examples further comprising identifying, by the one or more processors and using the natural language model, a rule attribute based at least in part on the natural language text of the natural language rule; generating, by the one or more processors, a real time label for the rule attribute; and modifying, by the one or more processors and via the interactive user interface, the natural language text to identify the real time label.

Example 10. The computer-implemented method of example 9, wherein generating the computer interpretable rule comprises: identifying, by the one or more processors, a computer interpretable template corresponding to the rule attribute; and generating, by the one or more processors, the computer interpretable rule based at least in part on the rule attribute and the computer interpretable template.

Example 11. The computer-implemented method of any of examples 9 or 10 further comprising: receiving, by the one or more processors and via the interactive user interface, labeling input comprising a label modification for the real time label; and modifying, by the one or more processors, the rule attribute corresponding to the real time label based at least in part on the label modification.

Example 12. A computing apparatus comprising at least one processor and at least one memory including program code, the at least one memory and the program code configured to, upon execution by the at least one processor, cause the computing apparatus to: provide for display, via an interactive user interface, a natural language rule comprising natural language text indicative of a performance condition for a machine learning model; generate, using a natural language model, a computer interpretable rule corresponding to the natural language rule based at least in part on the natural language text, wherein the computer interpretable rule comprises a labeling function that corresponds to the performance condition; generate, using a weak supervision model, a labeled training dataset based at least in part on the computer interpretable rule; generate the machine learning model based at least in part on the labeled training dataset; and provide for display, via the interactive user interface, evaluation data for the machine learning model.

Example 13. The computing apparatus of example 12 further configured to generate, using the machine learning model, one or more performance metrics for the machine learning model; and generate the evaluation data for the machine learning model based at least in part on the one or more performance metrics, wherein the evaluation data is indicative of an association between the natural language rule and the one or more performance metrics.

Example 14. The computing apparatus of any of examples 12 or 13 further configured to: receive, via the interactive user interface, natural language text input comprising a rule modification to the natural language rule.

Example 15. The computing apparatus of example 14, wherein the rule modification is based at least in part on the evaluation data.

Example 16. The computing apparatus of any of examples 12 through 15, wherein the machine learning model is generated based at least in part on a plurality of natural language rules, wherein the evaluation data is indicative of a relative performance of the machine learning model relative to a previous model generated without the natural language rule.

Example 17. The computing apparatus of example 16, wherein the previous model is a rules-based model defined by a plurality of structured language rules, and the computing apparatus is further configured to: generate the natural language rule based at least in part on a particular structured language rule of the plurality of structured language rules.

Example 18. A non-transitory computer storage medium comprising instructions that, when executed by one or more processors, cause the one or more processors to: provide for display, via an interactive user interface, a natural language rule comprising natural language text indicative of a performance condition for a machine learning model; generate, using a natural language model, a computer interpretable rule corresponding to the natural language rule based at least in part on the natural language text, wherein the computer interpretable rule comprises a labeling function that corresponds to the performance condition; generate, using a weak supervision model, a labeled training dataset based at least in part on the computer interpretable rule; generate the machine learning model based at least in part on the labeled training dataset; and provide for display, via the interactive user interface, evaluation data for the machine learning model.

Example 19. The non-transitory computer-readable storage medium of example 18, wherein the natural language rule is selected from a rule database associated with a plurality of predictive models, wherein the rule database comprises data indicative of: (i) a plurality of computer interpretable rules and a plurality of natural language rules, and (ii) one or more rule associations that identify one or more correlations between the plurality of computer interpretable rules and the plurality of natural language rules.

Example 20. The non-transitory computer-readable storage medium of example 19, wherein the one or more processors are further caused to: store the computer interpretable rule in association with the natural language rule in the rule database.

1. A computer-implemented method, the computer-implemented method comprising:
providing for display, by one or more processors and via an interactive user interface, a natural language rule comprising natural language text indicative of a performance condition for a machine learning model;
generating, by the one or more processors and using a natural language model, a computer interpretable rule corresponding to the natural language rule based at least in part on the natural language text, wherein the computer interpretable rule comprises a labeling function that corresponds to the performance condition;
generating, by the one or more processors and using a weak supervision model, a labeled training dataset based at least in part on the computer interpretable rule;
generating, by the one or more processors, the machine learning model based at least in part on the labeled training dataset; and
providing for display, by the one or more processors and via the interactive user interface, evaluation data for the machine learning model.

2. The computer-implemented method of claim 1 further comprising:
generating, by the one or more processors and using the machine learning model, one or more performance metrics for the machine learning model; and
generating, by the one or more processors, the evaluation data for the machine learning model based at least in part on the one or more performance metrics, wherein the evaluation data is indicative of an association between the natural language rule and the one or more performance metrics.

3. The computer-implemented method of claim 1 further comprising:
receiving, by the one or more processors and via the interactive user interface, natural language text input comprising a rule modification to the natural language rule.

4. The computer-implemented method of claim 3, wherein the rule modification is based at least in part on the evaluation data.

5. The computer-implemented method of claim 1, wherein the machine learning model is generated based at least in part on a plurality of natural language rules, wherein the evaluation data is indicative of a relative performance of the machine learning model relative to a previous model generated without the natural language rule.

6. The computer-implemented method of claim 5, wherein the previous model is a rules-based model defined by a plurality of structured language rules, and the computer-implemented method further comprises:
generating, by the one or more processors, the natural language rule based at least in part on a particular structured language rule of the plurality of structured language rules.

7. The computer-implemented method of claim 1, wherein the natural language rule is selected from a rule database associated with a plurality of predictive models, wherein the rule database comprises data indicative of:
(i) a plurality of computer interpretable rules and a plurality of natural language rules, and
(ii) one or more rule associations that identify one or more correlations between the plurality of computer interpretable rules and the plurality of natural language rules.

8. The computer-implemented method of claim 7 further comprising:
storing, by the one or more processors, the computer interpretable rule in association with the natural language rule in the rule database.

9. The computer-implemented method of claim 1 further comprising:
identifying, by the one or more processors and using the natural language model, a rule attribute based at least in part on the natural language text of the natural language rule;
generating, by the one or more processors, a real time label for the rule attribute; and
modifying, by the one or more processors and via the interactive user interface, the natural language text to identify the real time label.

10. The computer-implemented method of claim 9, wherein generating the computer interpretable rule comprises:
identifying, by the one or more processors, a computer interpretable template corresponding to the rule attribute; and
generating, by the one or more processors, the computer interpretable rule based at least in part on the rule attribute and the computer interpretable template.

11. The computer-implemented method of claim 9 further comprising:
receiving, by the one or more processors and via the interactive user interface, labeling input comprising a label modification for the real time label; and
modifying, by the one or more processors, the rule attribute corresponding to the real time label based at least in part on the label modification.

12. A computing apparatus comprising at least one processor and at least one memory including program code, the at least one memory and the program code configured to, upon execution by the at least one processor, cause the computing apparatus to:
provide for display, via an interactive user interface, a natural language rule comprising natural language text indicative of a performance condition for a machine learning model;
generate, using a natural language model, a computer interpretable rule corresponding to the natural language rule based at least in part on the natural language text, wherein the computer interpretable rule comprises a labeling function that corresponds to the performance condition;
generate, using a weak supervision model, a labeled training dataset based at least in part on the computer interpretable rule;
generate the machine learning model based at least in part on the labeled training dataset; and
provide for display, via the interactive user interface, evaluation data for the machine learning model.

13. The computing apparatus of claim 12 further configured to:
generate, using the machine learning model, one or more performance metrics for the machine learning model; and
generate the evaluation data for the machine learning model based at least in part on the one or more performance metrics, wherein the evaluation data is indicative of an association between the natural language rule and the one or more performance metrics.

14. The computing apparatus of claim 12 further configured to:
receive, via the interactive user interface, natural language text input comprising a rule modification to the natural language rule.

15. The computing apparatus of claim 14, wherein the rule modification is based at least in part on the evaluation data.

16. The computing apparatus of claim 12, wherein the machine learning model is generated based at least in part on a plurality of natural language rules, wherein the evaluation data is indicative of a relative performance of the machine learning model relative to a previous model generated without the natural language rule.

17. The computing apparatus of claim 16, wherein the previous model is a rules-based model defined by a plurality of structured language rules, and the computing apparatus is further configured to:
generate the natural language rule based at least in part on a particular structured language rule of the plurality of structured language rules.

18. A non-transitory computer storage medium comprising instructions that, when executed by one or more processors, cause the one or more processors to:
provide for display, via an interactive user interface, a natural language rule comprising natural language text indicative of a performance condition for a machine learning model;
generate, using a natural language model, a computer interpretable rule corresponding to the natural language rule based at least in part on the natural language text, wherein the computer interpretable rule comprises a labeling function that corresponds to the performance condition;
generate, using a weak supervision model, a labeled training dataset based at least in part on the computer interpretable rule;
generate the machine learning model based at least in part on the labeled training dataset; and
provide for display, via the interactive user interface, evaluation data for the machine learning model.

19. The non-transitory computer-readable storage medium of claim 18, wherein the natural language rule is selected from a rule database associated with a plurality of predictive models, wherein the rule database comprises data indicative of:
(i) a plurality of computer interpretable rules and a plurality of natural language rules, and
(ii) one or more rule associations that identify one or more correlations between the plurality of computer interpretable rules and the plurality of natural language rules.

20. The non-transitory computer-readable storage medium of claim 19, wherein the one or more processors are further caused to:
store the computer interpretable rule in association with the natural language rule in the rule database.
